(19) United States
(12) Patent Application Publication
(10) Pub. No.: US 2004/0053000 A1
(43) Pub. Date: Mar. 18, 2004

(54) Mat

(76) Inventor: Jacobus Noels, Heerhugowaard (NL)

Correspondence Address: YOUNG & THOMPSON, 745 SOUTH 23RD STREET 2ND FLOOR, ARLINGTON, VA, 22202

(21) Appl. No.: 10/415,069

(22) PCT Filed: Oct. 25, 2001
(86) PCT No.: PCT/NL01/00779

(30) Foreign Application Priority Data
Oct. 25, 2000 (NL) 1016481

(51) Int. Cl. B32B 3/10

(52) U.S. Cl. 428/54; 428/58

(57) ABSTRACT

The invention concerns a mat for use at the entrance of a building. The mat comprises at least one mat element with a lengthwise direction and widthwise direction which together encompass a mat surface, and also a thickness direction transversely to the mat surface. The mat element is composed of: a plurality of extruded rigid bearing sections made of a relative rigid plastic running parallel to each other and in the lengthwise direction; and also between adjoining bearing sections in each case an intermediate strip of a supple plastic, which is coextruded with the bearing sections and extends in the lengthwise direction parallel to the surface of the mat and connects the adjoining bearing sections to each other. On the top side, viewed in the thickness direction, the bearing sections are provided with top anti-slip covering strips of plastic, coextruded with the bearing sections.

The present invention relates to a mat for use at the entrance of a building, comprising at least one mat element with a lengthwise direction and widthwise direction, which together encompass a mat surface, and also a thickness direction transversely to the mat surface.

Such mats are known. An example that can be mentioned is the applicant's Dutch Patent NL-1,002,694. This mat is composed of a number of elongated, relatively flat aluminium sections, of which in each case the right-hand longitudinal side of the first section can be connected by means of a snap connection to the left-hand longitudinal side of a second section. These sections, the basic sections of the mat, form a relatively rigid unit if connected to each other. The basic sections themselves are made of a rigid material, for example of aluminium or plastic. In order to provide a tread surface, strips of a relatively supple material are clamped on the sections between projections on the basic section. When a mat of the type known from NL-1,002,694 is used in the case of buildings where there is heavy traffic in and out such as, for example, large department stores, then large amounts of sand collect daily on such a mat. In the case of large department stores it frequently happens that over fifteen litres of sand is deposited on a mat in one day. In the case of the mat known from NL-1,002,694 this sand collects on the mat. The collection capacity for sand is, of course, limited here to the spaces between the strips of a relatively supple material forming the tread surface. This mat is consequently not very suitable for entrances to a building with heavy traffic, or the sand has to be removed very frequently, for example with a vacuum-cleaning unit, or by lifting the fairly rigid mat as a whole and placing it at an angle or possibly turning it over, so that a large part of the sand will fall off it. In order to increase the collection capacity, it would have to be possible to provide sand passages in the collection spaces, for example, so that sand could fall through the mat and be collected underneath the mat. It should, however, be clear that this sand also will have to be removed regularly, generally daily. To that end, the mat has to be lifted, or at any rate partially removed, in order to make the collection space underneath the mat accessible. It should be remembered here that mats used in the case of large department stores can have very large dimensions, and are consequently heavy and relatively unmanageable. The activities involved in the complete or partial removal of the mat are laborious as a result of this, at least in the case of the mats known from NL-1,002,694 and also other prior art The main object of the invention is, however, to provide a mat that is considerably improved compared with the prior art.

A further object of the present invention is to provide a mat of the type mentioned at the beginning, which is relatively simple to produce, which is very maintenance-friendly as regards cleaning activities, and which in particular also has a great bearing capacity as regards persons and possibly even vehicles passing over the mat.

The abovementioned main object and also a large number to all of the further abovementioned objects are achieved according to the invention by the provision of a mat for use at the entrance of a building, comprising at least one mat element with a lengthwise direction and widthwise direction, which together encompass a mat surface, and also a thickness direction extending transversely to the mat surface, the mat element being composed of:

a number of extruded rigid bearing sections made of a relatively rigid plastic, for example unplaticized PVC, running parallel to each other and in the lengthwise direction, and also

between adjoining bearing sections in each case a flexible intermediate strip of a relatively supple plastic, for example plasticized PVC, which is coextruded with the b i sections and extends in the lengthwise direction parallel to the surface of the mat and connects the adjoining bearing sections to each other, and in which on the top side, viewed in the thickness direction, the bearing sections are provided with top anti-slip covering strips of plastic, for example plasticized PVC or a rubber-like material, which is coextruded with the bearing sections.

The mat element can be produced by co-extrusion in one production step, which renders subsequent assembly for the interconnection of various parts of the mat element unnecessary. The bearing sections, which are made of a relatively rigid plastic, provide the mat in a simple manner with relatively great bearing power, which in the case of use of very popular rigid/unplaticized plastics is already more tan sufficient to allow even vehicles, such as pallet trucks, to travel (back and forth) over the mat. The intermediate strips coextruded with the bearing sections, made of a relatively supple plastic, ensure that the mat element, and therefore also the mat comprising one or more of such mat elements, is very easy to roll up. The roll-up diameter at the start of rolling up can be very small here when fairly popular supple plastics are used. This minimal roll-up radius at the start of rolling up may even be substantially dependent upon the height of the bearing sections, viewed in the thickness direction. The anti-slip covering strips of plastic on the top side of the bearing sections, which covering strips have been coextruded along with the bearing sections, on the one hand, ensure that pedestrians passing over the mat can obtain sufficient grip on the relatively rigid (consequently more or less inherently automatically less slip-resistant) plastic bearing section and, on the other hand, make it slightly more comfortable to walk on the mat, owing to the fact that the anti-slip covering strips feel softer than the relatively rigid plastic required for the bearing sections. The anti-slip covering strips will generally be made of rubber-like material, or at any rate material that is relatively softer than that of the bearing sections. Such a mat element according to the invention, which is made entirely of plastic, can also be produced with a relatively low weight per m².

In order to reduce the weight per m² of a mat element, it is very advantageous according to the invention if the bearing sections are hollow tubular sections of a preferably essentially rectangular cross-sectional shape.

In order to make the mat usable on both sides, it is preferable according to the invention if the bearing sections are also provided on the bottom side, viewed in the thickness direction, with bottom anti-slip covering strips made of plastic that have been coextruded with the bearing sections. It should be clear here that the terms bottom side and top side in this case do not relate so much to the side in use, but rather indicate a distinction between the one side and the other, opposite side.

According to a further advantageous embodiment of the invention, the top surface and/or bottom surface of the top and/or bottom anti-slip covering strips respectively have at least two ribs extending in the lengthwise direction, with a recess between them. In the case of such an embodiment, the anti-slip covering strips can have an effect that is comparable to a window squeegee as regards wet soles of shoes of persons passing over the mat. Persons passing over the mat can then discard moisture adhering to the soles of their shoes onto the mat by making a sweeping movement with their shoes over the mat.

In order to increase the collection capacity for sand, it is preferable according to the invention if the intermediate strips are provided with passages going through them in the thickness direction, for example slits. Slits are preferred because they also readily allow through larger sand particles or wet sand particles.

The mat according to the invention described so far can essentially be composed of one mat element that can have very large dimensions, or of several to even a very large number of mat elements. During the assembly of the mat according to the invention from several, in particular at least two, mat elements, it is advantageous according to the invention if such a mat comprises a connecting section situated between said at least two mat elements, if the mat elements and the connecting section are provided with connecting means that mate with each other, such as snap connection means, which connect the one longitudinal side of the one mat element and the other longitudinal side of the other mat element to opposite longitudinal sides of the connecting section. The connecting section forms, as it were, an intermediate piece that connects two individual mat elements to each other. It is possible in this way to make the connecting section of a totally different material from that of the mat element, such as, for example, of aluminium or a plastic, for example fibre-reinforced plastic with great bearing capacity. Such a connecting section makes it possible to support a mat according to the invention on supporting surfaces running in the widthwise direction and having relatively large distances between them in the lengthwise direction. Such a connecting section also makes it possible to achieve great stability in the lengthwise direction of the mat at relatively great to even very great length measurements of the mat.

According to an advantageous embodiment of the invention, the connecting means, in particular snap connection means, are obtained by barbed connecting parts that engage in an undercut cavity.

With a view to permitting the mat according to the invention to be rolled up in a compact manner, it is further preferable if, viewed in the widthwise direction, the width of the connecting section divided by the width of the mat element is less than ⅓, preferably less than 3/10, for example even less than ⅕.

As a result of the at least one mat element being capable of being rolled up in a compact manner, and of the fact that a mat is composed of at least one mat element, such mat elements or mats can be stored and transported in a compact manner, for example can be sent by post.

The present invention will be explained in greater detail below with reference to an exemplary embodiment shown in the drawing, in which:

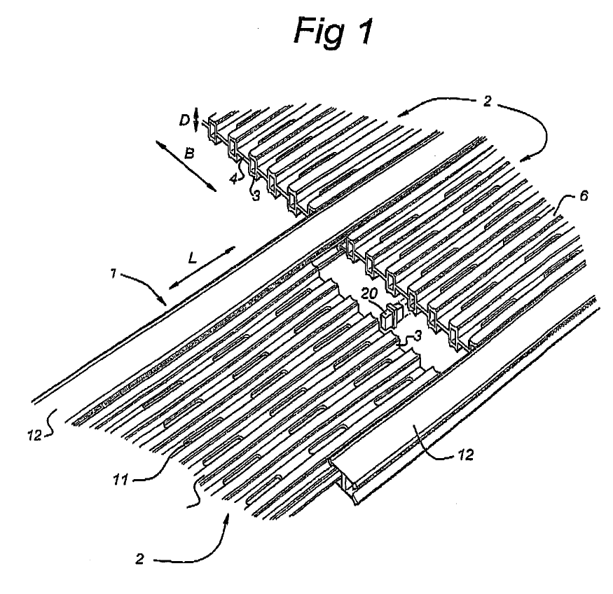

FIG. 1 shows a perspective view of a part of a mat according to the invention;

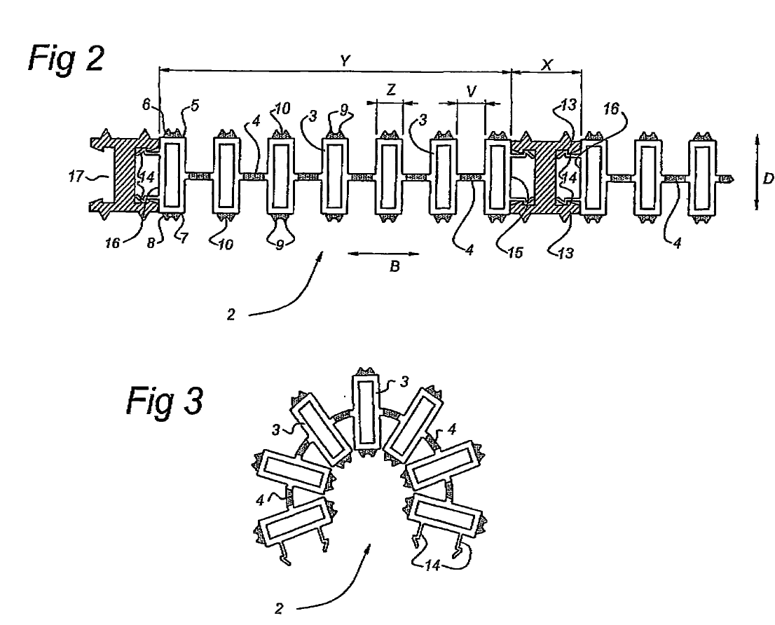

FIG. 2 shows a vertical cross-sectional view of a part of a mat according to the invention; and

FIG. 3 shows a side view with a mat element according to the invention rolled up to a minimal radius of curvature,

The mat according to the invention, or the mat element according to the invention, has a lengthwise direction L and a widthwise direction B, which together encompass the mat surface, in other words the surface in which the mat extends, and also a thickness direction D transversely to said mat surface.

Referring to FIGS. 1-3, the mat element 2 according to the invention is composed of essentially three coextruded plastics, two of which may be identical to each other, if desired. The mat elements 2 illustrated consist of seven bearing sections 3, in particular rectangular tubular bearing sections, of a relatively rigid plastic. The bearing sections 3 are interconnected in the widthwise direction by intermediate strips 4, coextruded along with the bearing sections 3 and made of a relatively supple plastic, in particular a supple plastic allowing bending. As can be seen in FIG. 1, the intermediate strips 4 can optionally be provided with slits 11. The slits 11 can be produced immediately downstream of the extrusion die, at some distance downstream of the extrusion die, by means of a punching device acting upon the extrudate. On the top side and the bottom side the bearing sections 3 are provided with an anti-slip covering 6 and 8 respectively, consisting of plastic strips, in particular made of a rubber-like material, coextruded along with the bearing sections 3. For the purpose of removing moisture from the soles of shoes, the anti-slip covering strips are provided on their working outside surface with two ribs 9, which have a recess 10 between them. The plastic used for the anti-slip covering strips 6 and 8 can, if desired, be made of the same plastic as that used for the intermediate strips 4, but in general these parts will be made of different plastics.

FIG. 3 shows that, as a result of the supple intermediate strips 4, a mat element 2 can be rolled up in a very compact manner. The compactness of the rolling up is largely still determined by the height of the bearing sections 3, viewed in the thickness direction D of the mat, and the width of the bearing sections 3, viewed in the widthwise direction B. For production reasons, namely keeping the extrusion die relatively compact, on the one hand, and with a view to the flexibility in the widthwise direction B of the mat according to the invention, on the other hand, it is preferable to give the mat elements 2 a relatively limited width Y and to provide them on their opposite longitudinal side with connecting means for connecting to the mat elements 2 adjoining each other in the widthwise direction B. This connection with adjoining mat elements is made very advantageously according to the invention by means of aluminium connecting sections 12.

The aluminium connecting sections 12, preferably extruded sections of aluminium or aluminium alloy, have on opposite longitudinal sides an undercut cavity 17 with two opposite inside wall parts provided with barbed sections. The outermost bearing sections 3 of the mat element 2, viewed in the widthwise direction B, are provided on their outside longitudinal sides with barbed connecting legs 14 that fit into the undercut cavities 17. The legs 14 will generally extend over the entire lengthwise direction L of a mat element 2.

The following dimensions of components of a mat according to the invention can be mentioned by way of example;

the width X of a connecting section: 15 mm;

the width Z of a bearing section: 4 mm;

the width V between adjoining bearing sections: 4 mm;

the width Y of a mat element (measured excluding the barbed legs 14): 52 mm;

As illustrated in FIG. 1, mat elements 2 adjoining each other in the lengthwise direction L can be interconnected by insert parts 20, which interconnect hollow tubular sections lying in line with each other. This has the advantage that when two mat elements 2 adjoining each other in the lengthwise direction L are being rolled up, it is ensured that one mat element does not bulge in one direction and the other mat element 2 in the opposite direction.

The construction of the mat 1 according to the invention, as illustrated in greater detail in FIG. 1, also has the advantage that, by using different colours of mat elements or mat elements with different colour shades, it is possible to form a mat containing a desired emblem or other type of drawing, possibly a text: It is relatively simple to produce mats with different motifs, which motifs can then be selected by the purchasers of the mat themselves. In connection with the formation of illustrations, emblems, drawings etc. in a mat according to the invention, a further great advantage is that, viewed in the lengthwise direction L, each mat element 2 can be made a variable length, which variable length can be selected depending entirely on what is desired, for example varying from 1 cm up to several metres. In particular, mat elements 2 with shorter dimensions in the lengthwise direction L in the range from 1 to 10 cm offer great possibilities for producing illustrations in a mat.

It should be clear that, despite the fact that only one insert part 20 is shown, all hollow tubular sections lying in line with each other can be through-connected by means of such an insert part 20, or only one or more hollow tubular sections lying in line with each other can be interconnected, if desired.

The mat described with reference to FIGS. 1-3 can be produced very easily with a weight of 10 g or less per m².

1. Mat (1) for use at the entrance of a building, comprising at least one mat element (2) with a lengthwise direction (L) and widthwise direction (B) which together encompass a mat surface, and also a thickness direction (D) transversely to the mat surface, the mat element (2) being composed of:
a plurality of at least two extruded rigid bearing sections (3) made of a rigid plastic, running parallel to each other and in the lengthwise direction, and also
between adjoining bearing sections (3) in each case a flexible intermediate strip (4) of a supple plastic, which is coextruded with the bearing sections (3) and extends in the lengthwise direction (L) parallel to the surface of the mat and connects the adjoining bearing sections (3) to each other, and
in which on the top side (5), viewed in the thickness direction (D), the bearing sections (3) are provided with top anti-slip covering strips (6) of plastic, coextruded with the bearing sections (3).

2. Mat (1) according to claim 1, in which the bearing sections (3) are hollow tubular sections of a preferably essentially rectangular cross-sectional shape.

3. Mat (1) according to one of the preceding claims, in which the bearing sections (3) are provided on the bottom side (7), viewed in the thickness direction (D), with bottom anti-slip covering strips (8) made of plastic that have been coextruded with the bearing sections (3).

4. Mat (1) according to one of the preceding clams, in which the top surface and/or bottom surface of the top and/or bottom (8) anti-slip covering strips respectively have at least two ribs (9) extending in the lengthwise direction, with a recess (10) between them.

5. Mat (1) according to one of the preceding claims, in which the intermediate strips (4) are provided with passages (11) going through them in the thickness direction (D), preferably slits,

6. Mat (1) according to one of the preceding claims, comprising at least two of said mat elements (2), and also comprising a connecting section (12) situated between said mat elements, the mat elements (2) and the connecting section (12) being provided with connecting means (13, 14) that mate with each other, such as snap connection means, which connect the one longitudinal side (15) of the one mat element (2) and the other longitudinal side (16) of the other mat element (2) to opposite longitudinal sides of the connecting section (12).

7. Mat according to claim 6, in which the connecting section (12) is made of metal, such as aluminium or an aluminium alloy, and is preferably extruded.

8. Mat according to claims 6 or 7, in which the connecting section (12) on two opposite longitudinal sides is provided with an undercut cavity (17) extending in the longitudinal direction and opening in the widthwise direction (B), and in which the mat elements (2) on the longitudinal sides are provided with one or two ribs (14) with a barbed cross-section, projecting in the widthwise direction and extending along the longitudinal direction.

9. Mat according to claim 8, in which the cavities (17) are provided on the inside with a barbed section that is complementary to the barbed ribs (14).

10. Mat according to one or more of the preceding claims 6-9, in which, viewed in the widthwise direction (B), the width (X) of the connecting section (12) divided by the width of the mat element (2) is less than ⅓, preferably less than 3/10, for example less than ⅕.
